(19) United States
(12) Patent Application Publication
(10) Pub. No.: US 2006/0291882 A1
(43) Pub. Date: Dec. 28, 2006

(54) Imaging machine using a large area electron multiplier

(75) Inventors: Andrew Tulloch, Reading (GB); Norman Leslie Pratt, Buntingford (GB)

Correspondence Address: BIRCH STEWART KOLASCH & BIRCH, PO BOX 747, FALLS CHURCH, VA, 22040-0747, US

(73) Assignee: COUNCIL FOR THE CENTERAL LABORATORY OF THE RESEARC, Warrington (GB)

(21) Appl. No.: 10/563,609

(22) PCT Filed: May 13, 2004
(86) PCT No.: PCT/GB04/02087

§ 371 Date: Jan. 6, 2006

(30) Foreign Application Priority Data
Jul. 9, 2003 (GB) 0316081.9
Jul. 9, 2003 (GB) 0316082.7

(51) Int. Cl. G03G 15/01

(52) U.S. Cl. 399/54

(57) ABSTRACT

The imaging machine which may form part of a photocopier, scanner or the like has a light source, a platen (21) consisting of an upper, light transparent plate (23) and beneath the upper plate an image collector unit (25) and an image data processor (30). The image collector unit (25) consists of a photosensitive sheet arranged above an array of electron multiplier channels. Light reflected from an object laid on the surface (24) of the upper plate (23) is converted by the photosensitive sheet into electrons that are multiplied by the electron multiplier channels to amplify the image of the object resting on the upper plate. The surface area of the electron multiplier array corresponds to the imaging area of the imaging machine making it possible for a complete image to be captured simultaneously across the entire imaging area rather than by means of scanning optics. Moreover, the use of the electron multiplier array enables lower powered light sources to be employed.

The present invention relates to an imaging machine employed in, but not limited to, scanners, photocopiers and fax machines.

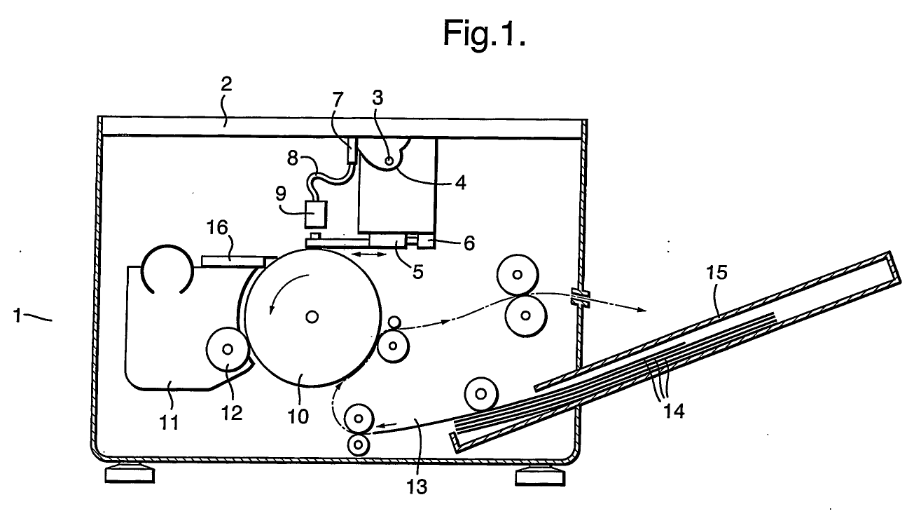

In recent years much research has been made into developing multi-tasking functions for machines such as photocopiers. Indeed, photocopiers capable of additionally functioning as network printers, scanners and fax machines are now commercially available. FIG. 1, which is taken from EP-A-0132306, is an example of such a multi-function machine which combines traditional copier technology with digital printing technology. The copier 1 comprises a transparent platen 2, usually of glass, which supports the document to be copied. Beneath the platen 2 is a longitudinal light source 3 which is positioned so as to extend the entire width of the platen 2 and is mounted in a curved mirror 4. Both the light source 3 and the mirror 4 are mounted on a sliding mount 5 the drive for which is provided by a solenoid 6. The sliding mount 5 is arranged to enable the transverse light source 3 in combination with the mirror 4 to travel the length of the platen 2. Also provided on the sliding mount 5 is a longitudinal object lens 7 which communicates via a flexible fibre optic cable 8 with a fixed longitudinal projection lens 9.

The copier illustrated in FIG. 1 is a conventional electrostatic photocopier and includes a rotating selenium drum 10 arranged beneath the longitudinal projection lens 9. A development unit 11 and magnetic inking roller 12 are also provided about the circumference of the drum 10 along with a sheet feed 13. The sheet feed unit 13, which removes individual sheets of paper from a cassette 14, includes a series of rollers for directing each sheet of paper to the surface of the drum 10 and then, after printing, back to a sheet collecting tray 15. In the case of FIG. 1, the upper surface of the cassette 14 also functions as the sheet collecting tray 15.

In use, the travel of the light source 3 and object lens 7 is synchronised with the rotation of the drum 10 so that the surface of the selenium drum 10 is illuminated with a series of image strips by means of the projection lens 9. Continued rotation of the drum 10 then brings the patterning of the strip images projected onto the drum surface into contact with the inking roller 12 and thereafter into contact with a sheet of paper from the sheet feed unit 13. The operation of electrostatic photocopiers of this type is well understood in the art.

To enable the photocopier to also function as a printer a separate printer unit 16 is provided at a position on the circumference of the drum intermediate the projection lens 9 and the inking roller 12. The printer unit 16 consists of a processor including a print driver in communication with a plurality of conductors arranged adjacent but separate from one another across the longitudinal width of the drum, each providing a dedicated electrically conductive path. An input/output interface (not illustrated), which is in communication with the printer unit 16, is also provided to receive print instructions for example from a computer network or as part of a fax modem. The tips of the conductors in the printer unit 16 are driven to charge the surface strips of the selenium drum 10 with the images to be printed.

Alternative developments in photocopier technology have wholly replaced the electrostatic photocopying functionality with digital print technology such as laser printing. In such cases the projection lens 9 of EP-A-0132306 is usually replaced with a strip array of CCDs. However, in all cases to date the document to be copied is scanned in strips or lines and the image strips or line data are subsequently reconstituted into an image of the entire document that is printed.

The present invention seeks to provide an improvement on existing imaging machines and in particular, but not exclusively, on imaging machines used as part of photocopiers, scanners or fax machines.

The present invention provides an image machine comprising an imaging unit and a data processing unit, the imaging unit comprising at least one light source and a plurality of image collectors, each image collector comprising a photosensitive element, a plurality of alternatively stacked layers of a dynode material and an electrical insulator mounted on a substrate, each stacked layer having one or more apertures which aligns with apertures in adjacent layers to form one or more channels extending through the stacked layers and closed at one end by the substrate, an anode provided at the closed end of the channels, and a signal connector connected to the anode and to the data processing unit, the data processing unit comprising at least one processor for generating image data based upon signals received from the plurality of image collectors.

Embodiments of the present invention will now be described by way of example only with reference to the accompanying drawings, in which:

FIG. 1 illustrates a conventional photocopier/printer;

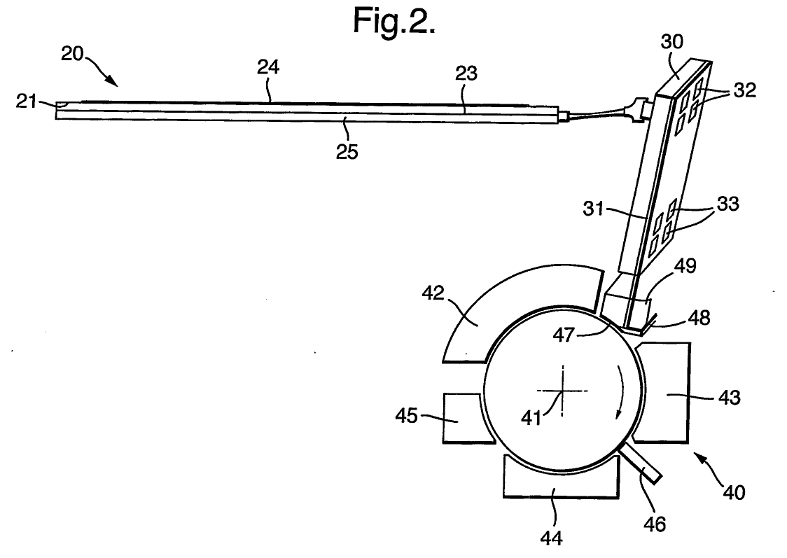

FIG. 2 illustrates schematically an imaging machine as part of a photocopier employing an electrostatic printer;

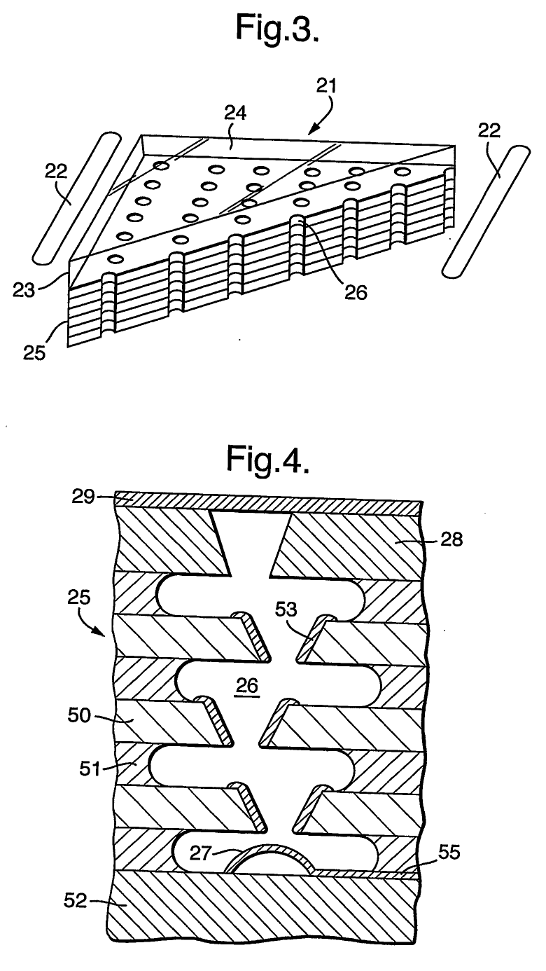

FIG. 3 is a cut-away perspective illustrating the image collector unit of the imaging machine in greater detail;

FIG. 4 is a schematic cross sectional view of a single channel of the image collector unit in accordance with the present invention.

The photocopier of FIG. 2 generally comprises an imaging unit 20, a data processing unit 30 and an electrostatic printer 40. The electrostatic printer 40 is similar to that described in EP-A-0132306 and consists of the following conventional items: a selenium drum 41, a corona assembly 42 for charging the drum, a development system 43 for providing an inked image on the drum, a transfer system 44 at which the inked image is transferred to a sheet of paper or the like, and drum cleaning means 45 for removing surplus ink remaining after the transfer process. Although not illustrated, it will be immediately apparent that the transfer system 44 includes a sheet storage and feed mechanism which is wholly conventional in structure and operation. An optical drum position encoder 46 is also provided and is illustrated positioned circumferentially of the drum. However, it is to be understood that alternative conventional means for monitoring the rotation and position of the drum may be employed and may, for example, be indirectly coupled to the drum.

The printer 40 also includes a longitudinal array of conductor tips 47 arranged across the width of the drum 41 and in sliding contact therewith for applying the image to be printed to the surface of the drum, as described in EP-A-0132306. The array of conductor tips 47 is mounted on a circuit board 48 which has the necessary driver electronic controls to separately drive the voltages applied to each of the conductor tips so that each conductor tip provides a dedicated electrically conductive path between the circuit board 48 and the drum 41. The circuit board 48 may include 800 separate conductors each of which terminates along a line approximately 20 cm long (in the case of A4 sheet printing). The pitch of the conductor tips at these dimensions is considered to be higher than the visible acuity of a human eye. That is to say the human eye is not considered to be capable of distinguishing between the images resulting from adjacent conductor tips. The circuit board 48 and the array of conductor tips 47 are supported on an insulated mount 49.

The data processing unit 30 is in communication with the printed circuit board 48 by means of a communications bus 31. The data processing unit 30 includes one or more processors 32 for generating print image data from the raw image data received from the imaging unit 20 and printer drivers 33 for controlling the operation of the circuit board 48 and the individual voltages applied to the conductor tips 47. The data processing unit 30 also includes one or more processors for controlling the functions of and the power supplied to the imaging unit 20.

As can be seen from FIG. 2, the imaging unit 20 is much simpler and smaller in size than conventional imaging units. The imaging unit consists of a platen 21 and one or more light sources 22 provided preferably at opposed edges of the platen 21 (see FIG. 3). The platen 21 has an upper light transparent plate 23 which contains internal facets to evenly distribute light from the light sources 22 at the edges of the platen to the upper surface 24 of the transparent plate onto which documents to be copied are placed. Beneath the transparent plate 23, the platen 21 further includes an image collector unit 25 preferably extending over the entire surface available for document imaging. The image collector unit 25, which is illustrated in greater detail in FIGS. 3 and 4, consists of a plurality of image collector channels in the form of an array of electron multiplier channels 26 (only one channel is illustrated in FIG. 4) each of which has a respective individually addressable anode 27 located at the bottom of the channel. The top or head of each channel, facing towards the transparent plate 23 is provided with photosensitive material 28. The photosensitive material 28 is generally selected on the basis of the wavelength(s) of light used to illuminate the document to be imaged and includes but is not limited to bialkali materials. The array of electron multiplier channels 26 with their respective anodes 27 and photosensitive material 28 are encased in an evacuated chamber. The upper wall 29 of the chamber 29, adjacent the light transparent plate 23, preferably includes a thin film of indium-tin-oxide (ITO) so that a potential can be applied to the upper wall of the chamber without unduly affecting the light transmissive properties of the upper chamber wall 29.

The array of electron multipliers is similar in construction to that described in EP-A-1004134 by the same author, the contents of which is incorporated herein by reference. The image collector unit 25 consists of a monolithic structure of alternatively stacked layers of a dynode material 50 and an insulator 51 on a substrate 52 with an array of channels 26 having been etched through the dynode 50 and insulator 51 layers. The dynode material is electrically conductive and is preferably a metal. However, other electrically-conductive materials suitable for use as the dynode material include, but are not limited to, high density graphite, pyrolytic carbon, rutile, doped alumina, doped zirconia or crystalline molybdenum. The channels 26 are etched so that they are staggered with the each dynode layer 50 projecting partially into the channels. At least a region of surfaces of the dynode layer 50 exposed in each channel are also coated in a secondary-electron emissive material 53 such as oxidised beryllium copper, lithium fluoride, sodium fluoride, sodium chloride, potassium chloride, rubidium chloride, caesium chloride, sodium bromide, potassium iodide, caesium dioxide or caesiated antimony.

Each dynode layer 50 also includes power connections so that a voltage may be applied to the layer. The voltage level applied to an individual dynode layer is dependent upon the position of the dynode layer in the stack of dynode layers such that increasing potentials are applied to the dynode layers in a direction towards the anode 27. Furthermore, each of the individual anodes 27 in the electron multiplier array includes a signal connection 55 for carrying a signal representative of the amount of light incident on the photosensitive material 28 at the head of each channel. Both the power connections and the signal connections 55 extend through the evacuated chamber 29 for connection to the data processing unit 30.

The channels 26 of the electron multiplier array are preferably arranged in a regular grid formation with a spacing of between 10 and 500 microns, preferably less than 100 microns. However, the arrangement of the channels and their associated anodes can be varied subject to the requirements of the image collector unit 25.

The apertures in each dynode layer 50 preferably have a diameter of between 10 and 100 microns. However, apertures having diameters between 1 and 1000 microns are also envisaged. The size of the apertures in the insulator layers 51 are greater than those in the dynode layers 50 and are preferably between 20-110 microns, though again apertures of diameters between 5 and 1100 microns are envisaged. In having larger apertures in the insulator layers 51, upper 60 and lower 61 surface edge regions of each dynode layer 50 are exposed. These exposed upper 60 and lower 61 surface edge regions ensure that, when an electron impacts the dynode layer 50, charge leakage across the dynode layer 50 is reduced.

The dynode layer 50 may be of any thickness greater than 1 micron and is preferably between 10 and 50 microns. The insulator layer 51 may similarly be of any thickness greater than 1 micron and is preferably between 10 and 50 microns. Moreover, the thickness of the dynode 50 layer is preferably that of the insulator layer 51. Ultimately, however, the thickness of each layer is a matter of design preference and may depend upon the desired characteristics of the image collector unit 25, as well as the choice of materials for the dynode layer 50 and insulator layer 51.

The thickness of the secondary-electron emission material 53 is preferably between 10 nm and 200 nm. Moreover, the emissive material 53 preferably has a secondary-electron emission coefficient of at least 5.

Two methods of fabricating the image collector unit 25 will now be described, both of which employ micro-engineering techniques. In the first method, an array of convex elements is provided on a substrate. The convex elements are preferably a thermally deformable plastics material that adopts a generally convex shape following exposure to heat. A thin metal film having a low second secondary-electron emission coefficient, such as a chrome:gold alloy, is then deposited over the surfaces of the convex elements and the exposed surface of the substrate. The thin metal film is then patterned leaving the surface of each convex element covered by the metal film to form an array of anodes. Each of the anodes also has a power supply connection in the form of a thin strip of the metal film. A first insulator layer is then applied over the surface of the substrate and the anodes through a mask. The first insulator layer is patterned by the mask so as to provide a plurality of apertures each in the form of a channel aligned with and exposing a respective anode. A filler material, such as a polyimide, is then deposited into the apertures so as to completely fill the apertures and extend over the exposed upper surface of the insulator layer. The filler material above the surface of insulator layer is subsequently removed so as to expose the surface of the insulator layer. A dynode layer is then deposited over the insulator layer and filler material through a mask. The dynode layer is patterned by the mask with a plurality of apertures, each aperture being associated with a respective anode. The apertures in the dynode layer are then filled with the same filler material. The filler material is removed back to the upper surface of the dynode layer. The fabrication steps described above are then repeated to create an alternating series of insulator and dynode layers. A photosensitive material is then applied to regions of the uppermost layer immediately adjacent each channel. Finally, electrical connections are made to each anode and each dynode layer and the entire structure is sealed inside a steel or glass package under vacuum.

Preferably, after the filler material is removed so as to expose the upper surface of the insulator layer or the dynode layer, a continuous seed layer in the form of a thin film is deposited over the exposed surface of the insulator or dynode layer and the filler material. Preferably, the seed layer is of the same material as the dynode layer. The seed layers ensure that each layer in turn is planarised across the surface of the multiplier array thereby minimising any variation in the thickness of each layer across the array.

In a second, alternative method, the image collector unit 25 is fabricated by stacking a plurality of dynode-insulator plates. Each dynode-insulator plate is manufactured by bonding a layer of dynode material to a layer of an electrical insulator. A mask defining a plurality of apertures is applied to the bonded layers and a jet of hard powders ablates corresponding apertures through both the dynode and insulator layers. The aperture walls in the insulator layer are thereafter selectively etched such that the apertures in the insulator layer have a greater diameter than those in the dynode layer. A layer of material chemically resistant to the selective etchant is preferably applied to the surface of the insulator layer remote from the dynode layer so that the thickness of insulator layer is maintained. The aperture walls of the dynode layer are then coated with a secondary-electron emissive material to create a single dynode-insulator plate having a plurality of apertures. A plurality of such dynode-insulator plates are then stacked together such that apertures in adjacent plates align to form a plurality of continuous electron multiplier channels. An end of the stacked structure is then closed by a substrate having a plurality of anodes, such as those described above for the first method, such that each electron multiplier channel is closed and has a respective anode. A photosensitive material is then applied to regions of the uppermost surface of the stack immediately adjacent each channel. Finally, electrical connections are made to each anode and each dynode layer and the entire structure is sealed inside a steel or glass package under vacuum.

In the embodiment described above, the document to be copied is illuminated by one or more light sources 22 provided at opposed edges of the platen 21. A light transparent plate 23 is also preferably provided to evenly distribute the light from the light sources 22. In an alternative embodiment, the light sources 22 are provided beneath the image collector unit 25 and the image collector unit 25 includes one or more through-channels through which the light from the light sources 22 is communicated to the document to be copied. In their simplest form, the through-channels are channels of the electron multiplier array that are not closed by the substrate. However, as the electron multiplier channels 26 are staggered, with each dynode layer 50 projecting partially into the channels 26, the through-channels are preferably channels having substantially straight-edged walls so that the light from the light sources 22 may be efficiently communicated to the document. The diameter of the through-channels is preferably greater that the average diameter of the electron multiplier channels 26 and is ideally at least 0.5 mm.

A through-channel in its simplest form (i.e. an open electron multiplier channel) is formed by etching that region of the substrate 52 that closes the electron multiplier channel 26. Naturally, when a channel 26 of the electron multiplier array is intended to be used as a through-channel, the anode 27 for that channel 26 is omitted in the construction of the array. A through-channel having a substantially straight-edged wall may be fabricated in a number of ways. It may be fabricated after the electron multiplier array has been constructed by etching a channel through the substrate 52 and the alternating dynode 50 and insulator layers 51. The etching may be positioned so as to correspond to an existing electron multiplier channel 26 such the staggered walls are in effect etched straight. Preferably, however, the through-channel is formed during the fabrication of the electron multiplier array. In addition to etching those apertures which ultimately form the electron multiplier channels 26, apertures are also etched in the dynode 50 and insulator layers 51 which then align to form through-channels. The regions of the substrate 52 exposed by the through-channels in the stacked dynode 50 and insulator layers 51 are then etched to open the through-channels. Alternatively, the surface of the substrate 52 remote from the stacked dynode 50 and insulator 51 layers may be etched to open the through-channels.

Where the light sources 22 are provided beneath the image collector unit, evenly distributed light may be achieved without the use of the light transparent plate 23. Alternatively, the light transparent plate 23 may be disposed between the light sources 22 and the image collector unit 25.

With existing imaging machines, such as photocopiers and image scanners, the imaging unit (i.e. the lens system or CCD array) captures only image strips. Accordingly, a complete copy of the document is only achieved by scanning the imaging unit across the full length of the document. Image reproduction can therefore prove time consuming, particularly where a large number of documents must be reproduced. With the image machine of the present invention, the need to move the imaging unit is no longer necessary and a complete copy of the document can be achieved almost instantaneously. Consequently, the imaging machine of the present invention is capable of sub-second scan rates and preferably has a scan rate no greater than 0.1 seconds.

The image resolution delivered by the image machine of the present invention is preferably at least 5 line pairs per mm and more preferably 50 line pairs per mm, although higher and lower resolutions are also achievable.

More importantly, perhaps, with existing photocopier machines, movement of the imaging unit as it scans the length of the document must be accurately synchronised with the printing drum. The imaging unit of the present invention, on the other hand, is completely static and thus the difficulties in achieving synchronisation do not arise.

The light source of existing imaging machines must be of sufficient intensity such that the light reflected from the document and focussed by the lens system is capable of imaging the printing drum. Accordingly, existing imaging machines suffer from the disadvantage that they require a powerful light source. In addition, the light source must remain illuminated whilst the imaging unit scans the length of the document. Consequently, the power consumed by the light source can be substantial. With the imaging machine of the present invention, a plurality of electron multipliers amplifies the light signal received at the photosensitive material. Accordingly, an image of the document can be produced using light sources of much lower intensity. This, coupled with the fact that the light source need only be on for a fraction of the time of existing imaging machines, leads to a decrease in power consumption. Additionally, the lifetime of the light source is increased.

The size of the imaging unit of the present invention preferably has a 1:1 relationship with the size of the effective imaging area of the imaging machine, i.e. there is a 1:1 relationship between the size of the imaging unit and the size of the image that is captured by the imaging unit. Consequently, there is no need for any lens system. The size of the imaging unit is preferably at least that of the document to be copied. In particular, the size of the imaging unit may be at least that of conventional document sizes, e.g. A3, A4 and A5. In having an imaging unit that is at least the size of the document to be copied, the need to move the imaging unit is removed. Accordingly, the imaging unit need not comprise any moving parts. This offers a significant technical advantage over existing imaging machines, particular in terms of the lifetime of the machines.

A further advantage of the imaging machine of the present invention is that selective copying of the source document is possible. In particular, the imaging machine may be programmed such that the imaging unit captures only a selected area of the document. The selected area need not to be limited to a rectangular or square area, but may include any arbitrary shape.

Where the imaging machine of the present invention is to be used with a roller-based printing unit, such as the electrostatic printer, the raw image data corresponding to the entire image of the document may be first broken up into image strips for printing purposes.

Whilst reference thus far has been made to an electrostatic printer, it will be immediately apparent that the imaging machine of the present invention, in having an imaging unit that generates digital images, may equally be used with digital printers, such as a laser printer. Again, the raw image data provided by the imaging unit may first be broken up into image strips for printing purposes.

1. An imaging machine comprising an imaging unit and a data processing unit, the imaging unit comprising at least one light source and a plurality of image collectors, each image collector comprising a photosensitive element, a plurality of alternatively stacked layers of a dynode material and an electrical insulator mounted on a substrate, each stacked layer having one or more apertures which aligns with apertures in adjacent layers to form one or more channels extending through the stacked layers and closed at one end by the substrate, an anode provided at the closed end of the channels, and a signal connector connected to the anode and to the data processing unit, the data processing unit comprising at least one processor for generating image data based upon signals received from the plurality of image colllectors.

2. An imaging machine as claimed in claim 1, wherein each image collector channel has a respective anode.

3. An imaging machine as claimed in either of claims 1, wherein each dynode layer is made of an electrically conductive material and at least a region of the surfaces of each dynode layer exposed in each channel is coated in a secondary-electron emissive material.

4. An imaging machine as claimed in claim 3, wherein the electrically-conductive dynode material is non-metallic.

5. An imaging machine as claimed in claim 1, wherein the walls of the apertures in each dynode layer are tapered towards the anode.

6. An imaging machine as claimed in claim 1 further comprising a light-transparent support for items to be imaged and wherein the plurality of image collectors are mounted within an evacuated chamber with the wall of the chamber facing the open ends of the image collector channels being in light communication with said light-transparent support.

7. An imaging machine as claimed in claim 6, wherein the at least one light source is positioned adjacent an edge of the light-transparent support, and the light-transparent support has internal facets to distribute light from the at least one light source to the surface of the transparent support remote from the plurality of image collectors.

8. An imaging machine as claimed in claim 6, wherein the substrate and the stacked layers of dynode material and electrical insulator of the image collectors include one or more through holes for permitting the passage of light and wherein the at least one light source is located adjacent the surface of the substrate facing away from the open ends of the image collector channels whereby the one or more through holes are adapted to transport light from the at least one light source to the light-transparent support.

9. An imaging machine as claimed in claim 8, wherein the wall of the evacuated chamber facing the open ends of the image collector channels is said light-transparent support.

10. An imaging machine as claimed in claim 1 having an image resolution of at least 5 line pairs per mm.

11. An imaging machine as claimed in claim 1, wherein the surface area of the plurality of image collectors corresponds to the imaging area of the imaging unit.

12. An imaging machine as claimed in claim 1, wherein the data processing unit generates image data based only upon signals received from a selected portion of the plurality of image collectors.

13. An imaging machine as claimed in claim 1 further comprising a printing unit in communication with the data processing unit for printing an image based on image data generated by the data processing unit.

14. An imaging machine as claimed in claim 13, wherein the image data generated by the data processing unit comprises a plurality of image strip data and the printing unit prints an image based upon the plurality of image strip data.

15. A photocopier machine comprising an imaging unit, a data processing unit and a printing unit in communication with the digital processing unit, the imaging unit comprising at least one light source, a light-transparent support and a plurality of image collectors, each image collector comprising a photosensitive element, plurality of alternatively stacked layers of a dynode material and an electrical insulator mounted on a substrate, each stacked layer having one or more apertures which aligns with apertures in adjacent layers to form one or more channels extending through the stacked layers and closed at one end by the substrate, an anode provided at the closed end of the channels, and a signal connector connected to the anode and to the data processing unit, the data processing unit comprising at least one processor for generating image data based upon signals received from the plurality of image collectors determining the image to be printed by the printing unit.
